(19) United States
(12) Patent Application Publication
(10) Pub. No.: US 2024/0089389 A1
(43) Pub. Date: Mar. 14, 2024

(54) OPTICAL DEVICE AND IMAGE READING DEVICE

(71) Applicant: FUJIFILM BUSINESS INNOVATION CORP, Tokyo (JP)

(72) Inventor: Masaki HACHISUGA, Kanagawa (JP)

(73) Assignee: FUJIFILM BUSINESS INNOVATION CORP, Tokyo (JP)

(21) Appl. No.: 18/157,530

(22) Filed: Jan. 20, 2023

(30) Foreign Application Priority Data
Sep. 9, 2022 (JP) 2022-143481

(51) Int. Cl. H04N 1/028; H04N 1/00

(52) U.S. Cl. CPC H04N 1/0281; H04N 1/00702; H04N 1/0075

(57) ABSTRACT

An optical device includes a light guiding unit that emits light to be guided to a predetermined position from a light emitting aperture, a detection unit that receives light reflected at the predetermined position, and a light blocking unit that includes a light blocking member located closer than an imaginary line to the detection unit in a cross section including the predetermined position and the light guiding unit, the imaginary line connecting the predetermined position and an end of the light emitting aperture that is far from the predetermined position in an optical axis direction.

### CROSS-REFERENCE TO RELATED APPLICATIONS

This application is based on and claims priority under 35 USC 119 from Japanese Patent Application No. 2022-143481 filed Sep. 9, 2022.

### BACKGROUND

### (i) Technical Field

The present disclosure relates to an optical device and an image reading device.

### (ii) Related Art

For example, Japanese Unexamined Patent Application Publication No. 2003-302504 discloses an optical device including a lens array unit. The lens array unit includes at least one lens array including a plurality of lenses arranged in rows and having a plurality of first lens surfaces on which light is incident and a plurality of second lens surfaces from which light is emitted and a first light-blocking mask having a plurality of through holes extending therethrough in the axial direction of each lens. The first light-blocking mask covers the front side of the lens array such that the plurality of through holes are located in front of their respective first lens surfaces. The lens array unit further includes a second light-blocking mask having a plurality of through holes extending therethrough in the axial direction of each lens. The second light-blocking mask is disposed behind the lens array such that the plurality of through holes are located behind their respective second lens surfaces.

### SUMMARY

Here, when a detection unit receives reflected light that is light guided by a light guiding unit and reflected at a predetermined position, a favorable image based on the reflected light can be obtained by blocking part of the light from the light guiding unit.

Aspects of non-limiting embodiments of the present disclosure relate to obtaining a detection image having a better image quality than that obtained in a configuration in which a detection unit receives reflected light while light from a light guiding unit is not blocked.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an optical device including a light guiding unit that emits light to be guided to a predetermined position from a light emitting aperture, a detection unit that receives light reflected at the predetermined position, and a light blocking unit that includes a light blocking member located closer than an imaginary line to the detection unit in a cross section including the predetermined position and the light guiding unit, the imaginary line connecting the predetermined position and an end of the light emitting aperture that is far from the predetermined position in an optical axis direction.

### BRIEF DESCRIPTION OF THE DRAWINGS

Exemplary embodiments of the present disclosure will be described in detail based on the following figures, wherein:

FIG. 1 is a schematic diagram illustrating a configuration of an image forming apparatus to which a first exemplary embodiment of the present disclosure is applied;

FIG. 2 is a schematic diagram illustrating a configuration of an image reading device to which the first exemplary embodiment is applied;

FIG. 3 is a diagram illustrating the state of reflected light, which is light reflected by a document on a transparent plate, being received by light receiving elements of a light receiving board;

FIGS. 4A and 4B are diagrams illustrating a configuration example of a first light-blocking wall, FIG. 4A being an exemplary perspective view, and FIG. 4B being another exemplary perspective view;

FIGS. 5A and 5B are diagrams illustrating a second light-blocking wall according to the first exemplary embodiment, FIG. 5A being a diagram illustrating a configuration of the second light-blocking wall, and FIG. 5B being a diagram illustrating light blocking results obtained by the second light-blocking wall;

FIGS. 6A to 6D are diagrams illustrating a second light-blocking wall according to a second exemplary embodiment, FIG. 6A being a diagram illustrating a configuration of the second light-blocking wall, and FIGS. 6B, 6C, and 6D being diagrams illustrating light blocking results obtained by the second light-blocking wall;

FIG. 7 is a diagram illustrating a second light-blocking wall according to a third exemplary embodiment;

FIGS. 8A and 8B are diagrams illustrating a second light-blocking wall according to a fourth exemplary embodiment, FIG. 8A being a diagram illustrating a configuration of the second light-blocking wall, and FIG. 8B being a diagram illustrating the state in which the first light-blocking wall and the microlens array are attached to the second light-blocking wall;

FIGS. 9A and 9B are diagrams illustrating a second light-blocking wall according to a fifth exemplary embodiment, FIG. 9A being a diagram illustrating a configuration of the second light-blocking wall, and FIG. 9B being a plan view of the second light-blocking wall; and

FIG. 10 is a diagram illustrating a second light-blocking wall according to a sixth exemplary embodiment.

### DETAILED DESCRIPTION

Exemplary embodiments of the present disclosure will be described in detail below with reference to the accompanying drawings. Note that the size, the thickness, and so forth of each component illustrated in the drawings that will be referred to in the following description may be different from the actual dimensions.

### <Image Forming Apparatus 100>

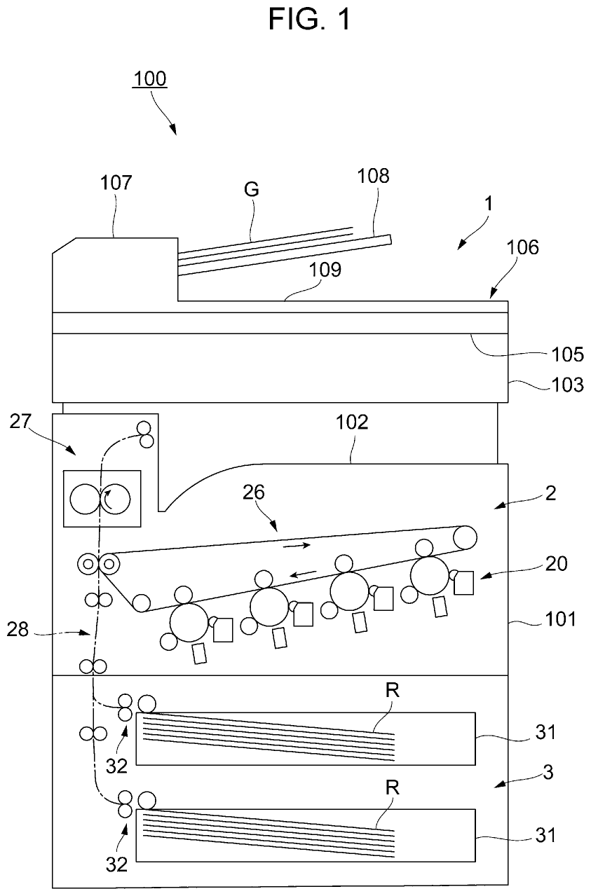

FIG. 1 is a schematic diagram illustrating a configuration of an image forming apparatus 100 to which the first exemplary embodiment is applied.

As illustrated in FIG. 1, the image forming apparatus 100 includes a document reading device 1 that reads information regarding documents G, an image forming section 2 that forms images onto recording sheets R on the basis of the information regarding the documents G (read images) read by the document reading device 1, and a sheet feeding section 3 that sends out the recording sheets R to be supplied to the image forming section 2. In the image forming apparatus 100, the image forming section 2 and the sheet feeding section 3 are accommodated in a body 101 of the image forming apparatus 100, whereas the document reading device 1 is disposed on an upper portion of the body 101. The body 101 includes an ejected-sheet receiving unit 102 provided on a top surface portion thereof, and the recording sheets R on which images have been formed are ejected to and received in the ejected-sheet receiving unit 102.

The document reading device 1 includes a housing 103. In addition, the document reading device 1 includes a document table 105 that is light-transmissive and onto which the documents G are placed and a document cover 106 that covers the document table 105 and that is capable of being opened and closed with respect to the housing 103, and the document table 105 and the document cover 106 are provided on a top surface portion of the housing 103. The document cover 106 is provided with an automatic document transport unit 107 that transports the documents G to a reading position and that ejects the documents G that have been read, a document tray 108 onto which the documents G which are to be sent by the automatic document transport unit 107 are placed, and a receiving unit 109 that receives the documents G ejected by the automatic document transport unit 107.

The image forming section 2 employs, for example, an electrophotographic system and includes image forming units 20 that form toner images of yellow (Y), magenta (M), cyan (C), and black (K), an intermediate transfer unit 26 that transports the toner images formed by the image forming units 20 such that the toner images are transferred onto the recording sheets R, and a fixing unit 27 that fixes the toner images, which have been transferred to the recording sheets R from the intermediate transfer unit 26, in place. Note that the image forming section 2 may employ, for example, an ink-jet system instead of the electrophotographic system and form images.

The sheet feeding section 3 includes an accommodating unit 31 that is capable of accommodating the plurality of recording sheets R, each of which is a predetermined type of sheet having a predetermined size and so forth, and capable of being drawn out from the image forming apparatus 100 and a delivery unit 32 that sends out the recording sheets R accommodated in the accommodating unit 31 one by one to a transport path. A supply transport path 28 is provided between the sheet feeding section 3 and the image forming section 2, and the recording sheets R sent out from the sheet feeding section 3 are transported along the supply transport path 28 to a second transfer position.

A basic operation of the image forming apparatus 100 will now be described.

First, in the document reading device 1, at least one of the documents G is placed onto the document table 105 or the document tray 108 by a user. Then, the user operates an operation button or the like (not illustrated), so that the document reading device 1 receives an instruction to read a document and starts performing an operation of reading the document G. In other words, the document reading device 1 reads the document G and acquires information regarding the document G. Subsequently, the image forming section 2 performs an image forming operation on the basis of the read information of the document G received from the document reading device 1. In this case, one of the recording sheets R is sent out from the sheet feeding section 3 in accordance with the timing at which the image forming section 2 performs the image forming operation. In the image forming section 2, toner images are fixed onto the recording sheet R, and then the recording sheet R is ejected to the ejected-sheet receiving unit 102. This image forming operation is repeated in a manner similar to the above the same number of times as the number of the documents G or the number of images to be formed.

### <Document Reading Device 1>

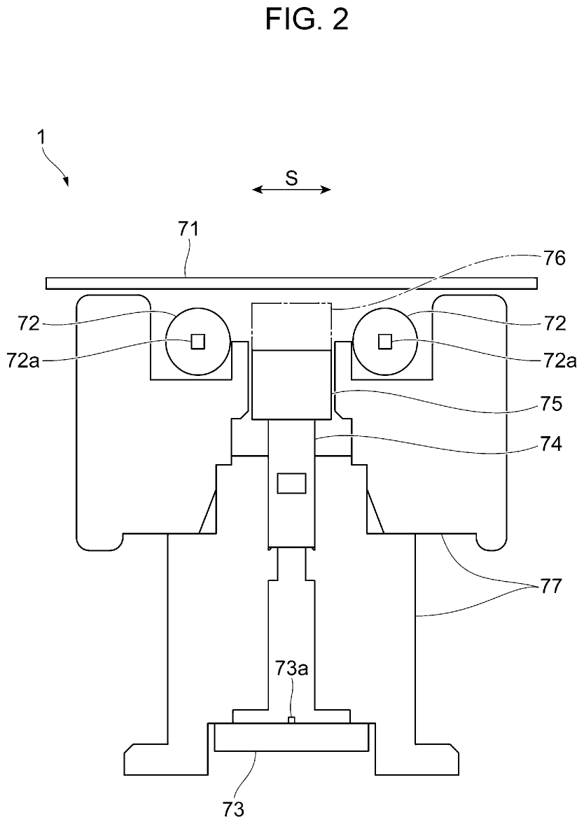

The document reading device 1 to which the present exemplary embodiment is applied will now be described with reference to FIG. 2. The document reading device 1 is an example of an optical device. A subscanning direction S is illustrated in FIG. 2.

FIG. 2 is a schematic diagram illustrating a configuration of the document reading device 1 to which the present exemplary embodiment is applied, and a direction perpendicular to the plane in FIG. 2 is a main scanning direction L.

As illustrated in FIG. 2, the document reading device 1 includes a transparent plate 71 having a top surface that supports a document, which is a reading target and which is not illustrated, light guides 72 that guide light of light sources 72a to a document, and a light receiving board 73 including light receiving elements 73a that receive reflected light that is light reflected by a document.

The light sources 72a and the light guides 72 are arranged so as to emit light in one direction with respect to a document and also to emit light in another direction with respect to the document.

The light receiving board 73 is positioned farther from the transparent plate 71 than each of the light guides 72 is. The light receiving elements 73a of the light receiving board 73 are arranged in a row so as to be spaced apart from one another in the main scanning direction L and receive reflect light.

The document reading device 1 further includes a microlens array 74, which includes a plurality of very small microlenses 74a, and first and second light-blocking walls 75 and 76 for blocking reflected light that should not enter the microlenses 74a.

The microlens array 74 is disposed in such a manner as to be elongated in the main scanning direction L.

The first and second light-blocking walls 75 and 76 are members elongated in the main scanning direction L. The first and second light-blocking walls 75 and 76 are positioned on the side on which light enters the microlens array 74 and limit the amount of light that enters each of the microlenses 74a of the microlens array 74 by blocking part of the light.

The document reading device 1 further includes a housing 77 holding the light guides 72, the light receiving board 73, the microlens array 74, the first light-blocking wall 75, and the second light-blocking wall 76.

The housing 77 positions the light receiving board 73, the microlens array 74, the first light-blocking wall 75, and the second light-blocking wall 76 with respect to the transparent plate 71.

Each of the light guides 72 is an example of a light guiding unit, and each of the light receiving elements 73a of the light receiving board 73 is an example of a detection unit. The second light-blocking wall 76 is an example of a light blocking unit.

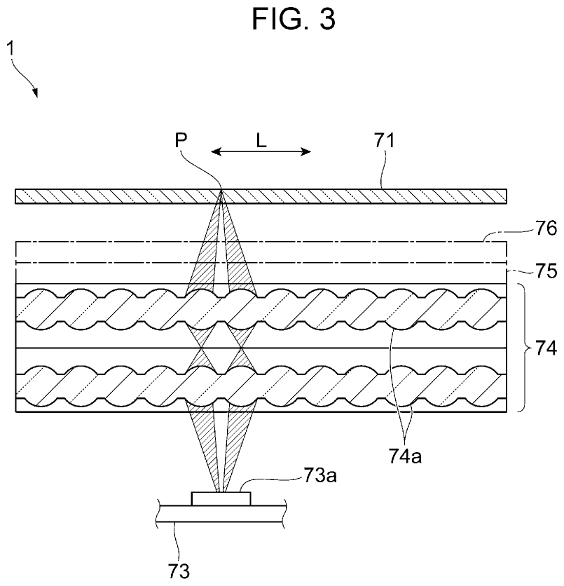

FIG. 3 is a diagram illustrating the state of reflected light, which is light reflected by a document on the transparent plate 71, being received by the light receiving elements 73a of the light receiving board 73. FIG. 3 is a sectional view taken along a direction perpendicular to the plane in FIG. 2, and the first and second light-blocking wall 75 and 76 are each indicated by a one-dot chain line in FIG. 3. The main scanning direction L is illustrated in FIG. 3.

The microlens array 74 illustrated in FIG. 3 is formed of two erect, unity-magnification imaging lens arrays in which variations in magnification due to displacement is less likely to occur. The two lens arrays of the microlens array 74 are arranged along the main scanning direction L such that the optical axis of each of the microlenses included in one of the lens arrays coincides with the optical axis of a corresponding one of the microlenses included in the other lens array.

The first light-blocking wall 75 is disposed between the transparent plate 71 and the microlens array 74 for a long depth of focus.

The second light-blocking wall 76 blocks light that is part of the light from the light guides 72 (see FIG. 2) and that is unnecessary for image formation before the unnecessary light reaches a document and is disposed between the transparent plate 71 and the first light-blocking wall 75.

A document reading position P is set with respect to the transparent plate 71, and part of light that is light reflected at the document reading position P, the part of the light not being blocked by the first light-blocking wall 75 and the second light-blocking wall 76, is received by the light receiving elements 73a through the microlens array 74.

The microlens array 74 is an example of a lens, and light reflected at the document reading position P is incident on the microlens array 74.

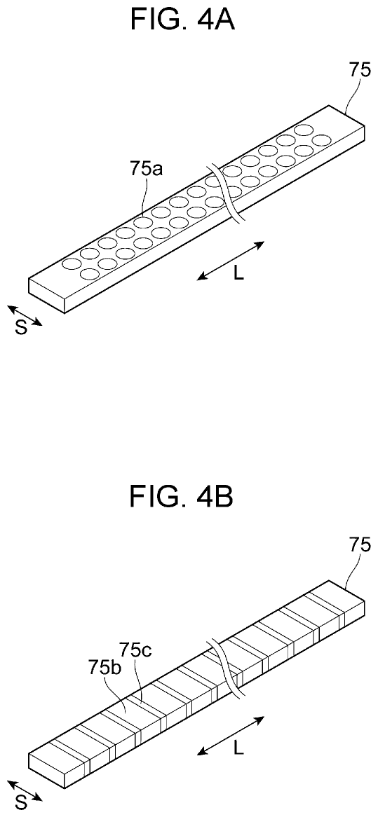

FIGS. 4A and 4B are diagrams illustrating a configuration example of the first light-blocking wall 75. FIG. 4A is an exemplary perspective view, and FIG. 4B is another exemplary perspective view.

The first light-blocking wall 75 illustrated as an example in FIG. 4A is, for example, a member that is made of a black synthetic resin having a light blocking property and that has a substantially plate-like or block-like shape extending in one direction. The first light-blocking wall 75 has a plurality of through holes 75a arranged so as to correspond to the arrangement of the plurality of microlenses 74a of the microlens array 74. The color of the inner wall surfaces of the through holes 75a is also black.

The first light-blocking wall 75 may be formed by resin molding using a metal mold, and the through holes 75a may be formed at the time of the resin molding or may be formed by machining or the like.

The first light-blocking wall 75 illustrated as another example in FIG. 4B is formed in such a manner that transmissive portions 75b that allow light to pass therethrough and light blocking portions 75c that block light are alternately arranged and connected to one another. The transmissive portions 75b are made of, for example, a material such as glass or a transparent resin, and the light blocking portions 75c are each formed of, for example, a light blocking film or are each made of, for example, a black adhesive.

The first light-blocking wall 75 is formed by cutting an integral member in which each of the light blocking portions 75c is sandwiched between a corresponding two of the transmissive portions 75b into predetermined dimensions and is not formed by resin molding using a metal mold.

### First Exemplary Embodiment

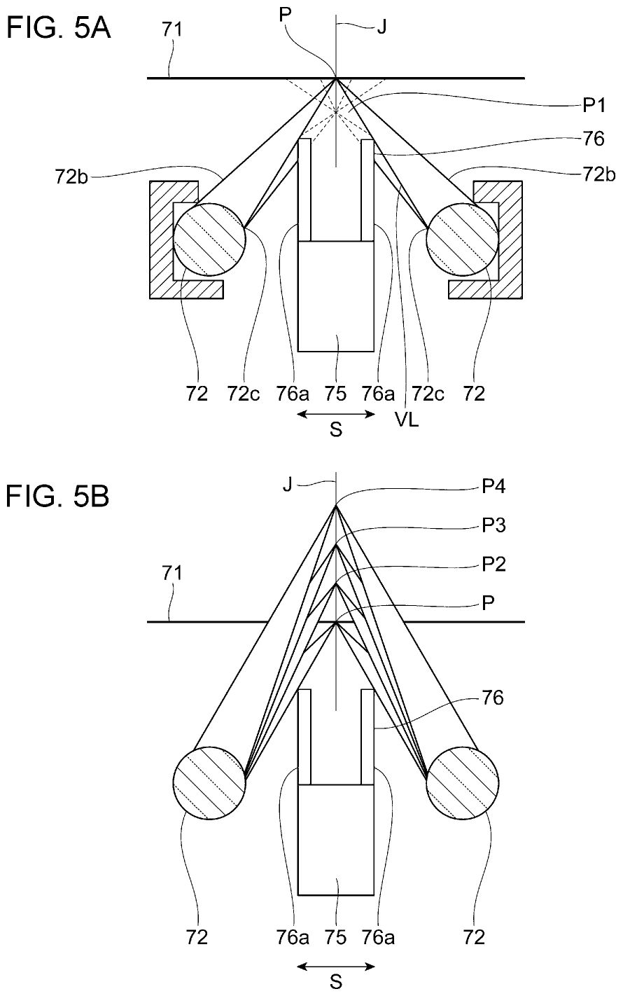

FIGS. 5A and 5B are diagrams illustrating the second light-blocking wall 76 according to the first exemplary embodiment. FIG. 5A is a diagram illustrating a configuration of the second light-blocking wall 76, and FIG. 5B is a diagram illustrating light blocking results obtained by the second light-blocking wall 76.

As illustrated in FIG. 5A, the second light-blocking wall 76 according to the first exemplary embodiment is disposed on the first light-blocking wall 75 so as to be positioned between the first light-blocking wall 75 and the document reading position P and includes a pair of members 76a and 76a each of which is a plate-shaped member. The pair of members 76a and 76a are each adjacent to a corresponding one of the light guides 72 and extend in a direction perpendicular to the plane in FIG. 5A, that is, the main scanning direction L (see, for example, FIG. 3) crossing the sub scanning direction S.

The pair of members 76a and 76a are arranged in such a manner as to be spaced apart from each other by a predetermined distance and are approximately parallel to each other. In other words, the distance between the pair of members 76a and 76a on one end side is substantially the same as that on the other end side.

In a cross section including the document reading position P and the light guides 72, the pair of members 76a and 76a of the second light-blocking wall 76 are located closer than imaginary lines VL each indicated by a one-dot chain line to the light receiving elements 73a (see FIG. 2). Each of the imaginary lines VL is an imaginary line connecting the document reading position P and an end 72c of one of light emitting apertures 72b that is far from the document reading position P in a direction in which an optical axis J extends, and in FIG. 5A, the imaginary lines VL overlap lines indicating light paths that are converged at the document reading position P.

The pair of members 76a and 76a are arranged so as not to block light paths of light that is emitted from the light guides 72, the light paths being converged at the document reading position P, and so as to block light paths to be converged at a position closer than the document reading position P to the light receiving elements 73a in the direction in which the optical axis J extends.

Thus, as illustrated in FIG. 5A, the pair of members 76a and 76a block light paths to be converged at a position P1 that is closer to the light guides 72 than the document reading position P is on the optical axis J. On the other hand, as illustrated in FIG. 5B, the pair of members 76a and 76a do not block light paths that are converged at document reading positions P2, P3, and P4 each of which is farther from the light guides 72 than the document reading position P is on the optical axis J.

The document reading positions P and P2 to P4 are each an example of a predetermined position. Note that FIG. 5A illustrates a cross section including the document reading positions P and P2 to P4 and the light guides 72.

Here, when one of the documents G (see FIG. 1) is brought into contact with the transparent plate 71, the document G is read at the document reading position P. The document G will not be positioned closer than the document reading position P to the light guides 72. Consequently, light that is to be converged at the position P1 illustrated in FIG. 5A is not used in a document reading operation, and thus, this light is unnecessary for image formation.

More specifically, there is a possibility that the unnecessary light converged at the position P1 will be reflected by the inner wall of the first light-blocking wall 75, which in turn results in fading of characters included in images detected by the light receiving elements 73a or blurring patches. Although performing sandblasting or coating on the first light-blocking wall 75 may be considered as a measure to address internal reflection of the unnecessary light, it is difficult to obtain a sufficient effect with such a measure.

Accordingly, in the first exemplary embodiment, the second light-blocking wall 76 that includes the pair of members 76a and 76a is provided for blocking unnecessary light, which is part of the light from the light guides 72, before the unnecessary light reaches the document G.

As illustrated in FIG. 5B, the second light-blocking wall 76 according to the first exemplary embodiment does not block the light paths that are converged at the document reading positions P2 to P4. Thus, in the case where one of the documents G (see FIG. 1) is spaced apart from the document reading position P due to the behavior of the document G while being transported, wrinkles in the document G, or the like, light is reflected at any one of the document reading positions P2 to P4, so that image reading may be performed.

The pair of members 76a and 76a of the second light-blocking wall 76 are each an example of a light blocking member of the light blocking unit.

### Second Exemplary Embodiment

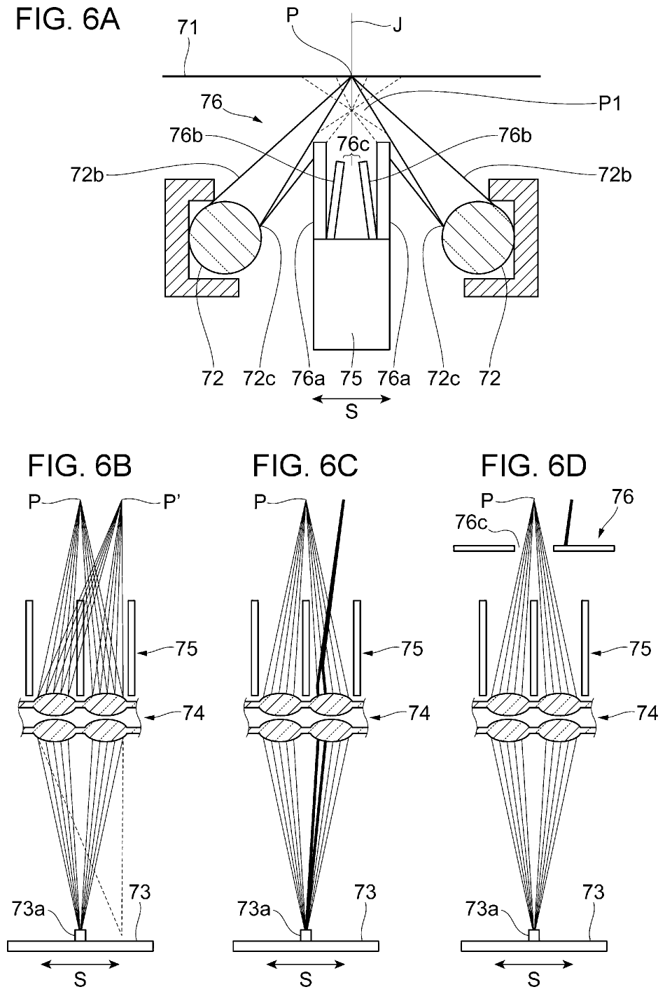

FIGS. 6A to 6D are diagrams illustrating the second light-blocking wall 76 according to the second exemplary embodiment. FIG. 6A is a diagram illustrating a configuration of the second light-blocking wall 76, and FIGS. 6B, 6C, and 6D are diagrams illustrating light blocking results obtained by the second light-blocking wall 76. FIG. 6A corresponds to FIG. 5A.

As illustrated in FIG. 6A, the second light-blocking wall 76 according to the second exemplary embodiment includes the pair of members 76a and 76a and also a pair of inclined members 76b and 76b each of which is a plate-shaped member. The pair of inclined members 76b and 76b are arranged between the pair of members 76a and 76a.

More specifically, the length of each of the pair of inclined members 76b and 76b is shorter than that of each of the pair of members 76a and 76a in the direction in which the optical axis J extends. In other words, the pair of inclined members 76b and 76b are more recessed than the pair of members 76a and 76a. Note that the pair of inclined members 76b and 76b may be located at the same positions as the pair of members 76a and 76a with respect to the direction in which the optical axis J extends or may project further than the pair of members 76a and 76a.

In addition, the pair of inclined members 76b and 76b are not parallel to the pair of members 76a and 76a and are inclined with respect to the pair of members 76a and 76a. In other words, the pair of inclined members 76b and 76b are inclined such that the distance between their end portions (their upper end portions in FIG. 6A) that are farther from the first light-blocking wall 75 is smaller than the distance between their other end portions (their lower end portions in FIG. 6A) that are closer to the first light-blocking wall 75. As a result, a slit 76c extending in a direction perpendicular to the plane in FIG. 6A (the main scanning direction L crossing the subscanning direction S (see, for example, FIG. 4A)) is formed on an incident side of the pair of inclined members 76b and 76b.

Here, for example, although the unnecessary light to be converged at the position P1 is blocked by the pair of members 76a and 76a before it reaches the document G, a case may be assumed in which light that is necessary for image formation is guided to the first light-blocking wall 75.

To be more specific, for example, as illustrated in FIG. 6B, main light that is light reflected at the document reading positions P and P2 to P4 (see FIGS. 5A and 5B) and that is indicated by solid lines in FIG. 6B enters the light receiving elements 73a. In contrast, light that is not the main light and that is converged at a position P′ does not enter the light receiving elements 73a.

However, as illustrated in FIG. 6C, a case may be assumed in which light that is reflected by the pair of members 76a and 76a (see FIG. 6A) of the second light-blocking wall 76 and that is indicated by bold lines in FIG. 6C enters the light receiving elements 73a as stray light.

Accordingly, as illustrated in FIG. 6D, the second light-blocking wall 76 according to the second exemplary embodiment further has the slit 76c for blocking stray light, the slit 76c being defined by the pair of inclined members 76b and 76b (see FIG. 6A).

As described above, the second light-blocking wall 76 according to the second exemplary embodiment also includes the pair of inclined members 76b and 76b that allow light reflected at the document reading positions P and P2 to P4 and travelling toward the light receiving elements 73a to pass through the pair of inclined members 76b and 76b and that do not allow light reflected at a position other than the document reading positions P and P2 to P4 and travelling toward the light receiving elements 73a to enter the pair of inclined members 76b and 76b. Note that, since the main light is not blocked by the slit 76c, the amount of light is not reduced.

Each of the pair of inclined members 76b and 76b of the second light-blocking wall 76 is an example of an edge portion.

### Third Exemplary Embodiment

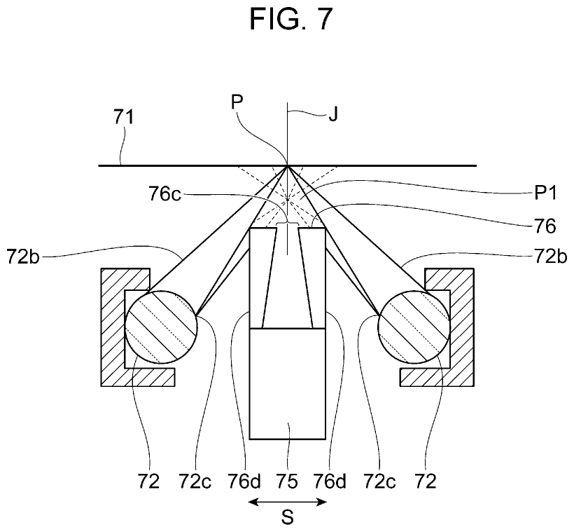

FIG. 7 is a diagram illustrating the second light-blocking wall 76 according to the third exemplary embodiment and corresponds to FIG. 6A.

The second light-blocking wall 76 according to the third exemplary embodiment illustrated in FIG. 7 includes a pair of block members 76d and 76d instead of the pair of members 76a and 76a and the pair of inclined members 76b and 76b according to the second exemplary embodiment (see FIG. 6A), each of the pair of block members 76d and 76d being formed by integrating one of the pair of members 76a and 76a and a corresponding one of the pair of inclined members 76b and 76b with each other. The block members 76d and 76d define the slit 76c as in the second exemplary embodiment.

As a result, in the third exemplary embodiment, the number of components included in the second light-blocking wall 76 is smaller than that in the second exemplary embodiment.

Each of the pair of block members 76d and 76d of the second light-blocking wall 76 is another example of the edge portion that is formed integrally with the light blocking member.

### Fourth Exemplary Embodiment

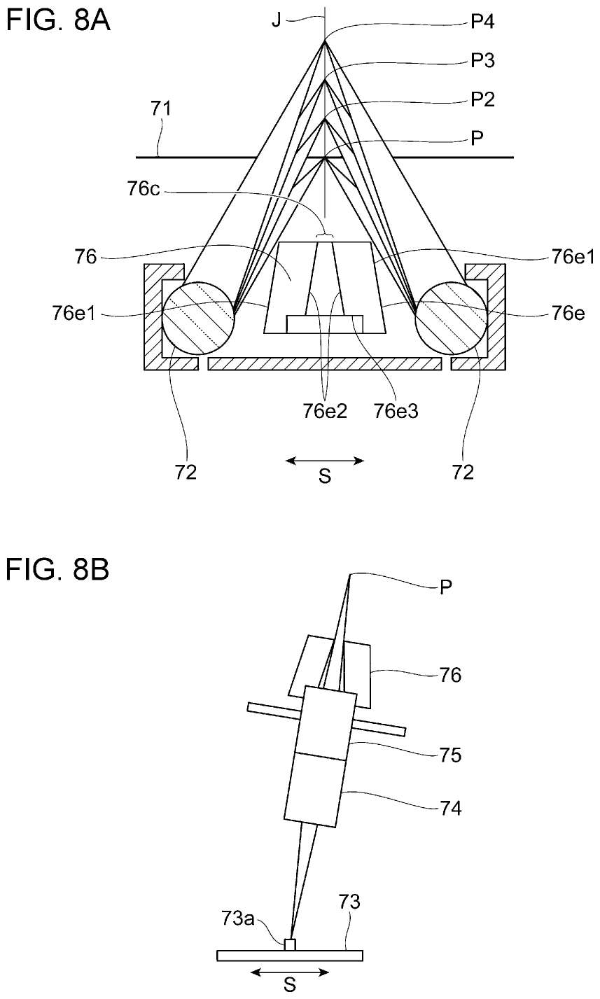

FIGS. 8A and 8B are diagrams illustrating the second light-blocking wall 76 according to the fourth exemplary embodiment. FIG. 8A is a diagram illustrating a configuration of the second light-blocking wall 76, and FIG. 8B is a diagram illustrating the state in which the first light-blocking wall 75 and the microlens array 74 are attached to the second light-blocking wall 76. FIG. 8A corresponds to FIG. 7.

The second light-blocking wall 76 according to the fourth exemplary embodiment illustrated in FIGS. 8A and 8B includes an integral block portion 76e instead of the pair of block members 76d and 76d according to the third exemplary embodiment (see FIG. 7), the integral block portion 76e being formed by integrating the pair of block members 76d and 76d with each other. The integral block portion 76e has the slit 76c having a predetermined width. The integral block portion 76e is an example of a member including the edge portion and the light blocking member integrally formed with each other.

The integral block portion 76e has outer surfaces 76e1 corresponding to surfaces of the pair of members 76a and 76a and inner surfaces 76e2 corresponding to surfaces of the pair of inclined members 76b and 76b. One of the outer surfaces 76e1 and a corresponding one of the inner surfaces 76e2 are inclined in the same direction, and the other outer surface 76e1 and the other inner surface 76e2 are inclined in the same direction, so that the integral block portion 76e has an approximately uniform thickness.

In addition, the inner surfaces 76e2 of the integral block portion 76e face toward the light receiving elements 73a of the light receiving board 73.

The integral block portion 76e has a recess 76e3 formed on the side opposite to the side on which the transparent plate 71 is disposed. The recess 76e3 is shaped in such a manner that the first light-blocking wall 75 is partially received in the recess 76e3. More specifically, as illustrated in FIG. 8B, the first light-blocking wall 75 is partially fitted into the recess 76e3 of the integral block portion 76e, so that the first light-blocking wall 75 and the microlens array 74 are positioned and mounted on the integral block portion 76e.

Here, the narrower the slit width of the slit 76c, a more favorable effect the slit 76c exhibits. However, if the slit 76c is too narrow, there is a possibility that the main light necessary for image formation will be blocked.

Accordingly, in the fourth exemplary embodiment, a configuration is employed in which the first light-blocking wall 75 and the microlens array 74 are mounted on the integral block portion 76e as illustrated in FIG. 8B.

### Fifth Exemplary Embodiment

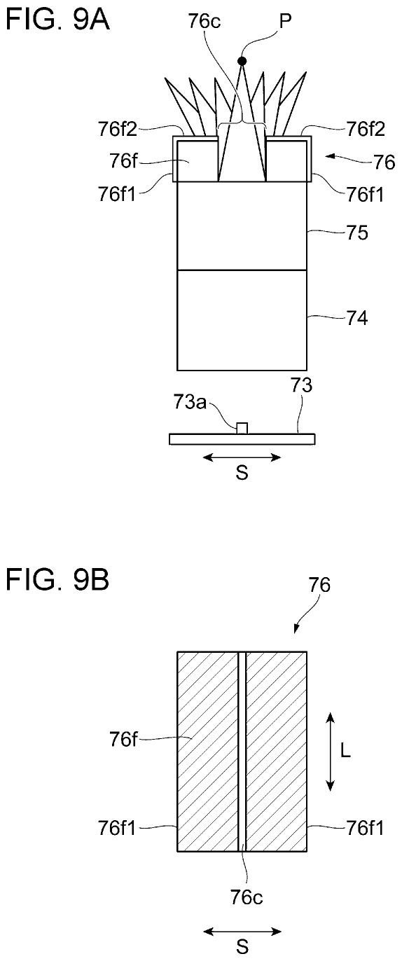

FIGS. 9A and 9B are diagrams illustrating the second light-blocking wall 76 according to the fifth exemplary embodiment. FIG. 9A is a diagram illustrating a configuration of the second light-blocking wall 76, and FIG. 9B is a plan view of the second light-blocking wall 76.

The second light-blocking wall 76 according to the fifth exemplary embodiment illustrated in FIG. 9A includes a transparent block portion 76f that is made of a resin and that allows light to pass therethrough. As illustrated in FIG. 9A, the first light-blocking wall 75 and the microlens array 74 are attached to the transparent block portion 76f As illustrated in FIG. 9A, the transparent block portion 76f includes printed portions 76f1 formed on side surfaces of the transparent block portion 76f and printed portions 76f2 formed on the top surface of the transparent block portion 76f facing the document reading position P. The printed portions 76f1 and 76f2 do not allow light to pass therethrough and are formed on surfaces of the transparent block portion 76f.

In the transparent block portion 76f, the printed portions 76f1 provide effects similar to those of the pair of members 76a and 76a in the above-described first exemplary embodiment (see FIG. 5A). In other words, the printed portions 76f1 do not block the light paths that are converged at the document reading position P and block light to be converged at a position between the document reading position P and the light guides 72 in the direction in which the optical axis J extends (see, for example, FIG. 8A).

Each of the printed portions 76f1 is another example of the light blocking member.

In addition, the transparent block portion 76f has the slit 76c defined by the printed portions 76f2, so that an effect similar to those of the pair of inclined members 76b and 76b in the above-described second exemplary embodiment (see FIG. 6A) is obtained.

In other words, the printed portions 76f2 allow light reflected at the document reading positions P and P2 to P4 (see, for example, FIG. 8A) and travelling toward the light receiving elements 73a to pass through the printed portions 76f2 and do not allow light reflected at a position other than the document reading positions P and P2 to P4 and travelling toward the light receiving elements 73a to enter the printed portions 76f2.

To be more specific, the printed portions 76f2 are not formed on a substantially central portion of the top surface of the transparent block portion 76f in the subscanning direction S, and the slit 76c for blocking stray light is formed in the substantially central portion. As illustrated in FIG. 9B, the slit 76c is formed so as to extend in the main scanning direction L.

Each of the printed portions 76f2 is another example of the edge portion.

More specifically, the transparent block portion 76f illustrated in FIG. 9A is in common with the integral block portion 76e of the fourth exemplary embodiment (see FIG. 8A) in that it is formed by integrating the pair of block members 76d and 76d in the third exemplary embodiment (see FIG. 7) with each other.

On the other hand, the transparent block portion 76f has a rectangular cross section, and the external shape of the transparent block portion 76f is simpler than that of the integral block portion 76e. In addition, the transparent block portion 76f is different from the integral block portion 76e in that reflected light passes through the resin in the transparent block portion 76f, whereas reflected light passes through air in the integral block portion 76e.

### Sixth Exemplary Embodiment

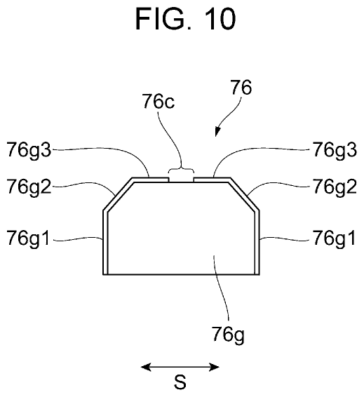

FIG. 10 is a diagram illustrating the second light-blocking wall 76 according to the sixth exemplary embodiment.

The second light-blocking wall 76 according to the sixth exemplary embodiment illustrated in FIG. 10 includes a transparent block portion 76g that is made of a resin and that allows light to pass therethrough. Note that, as in the fifth exemplary embodiment, the first light-blocking wall 75 and the microlens array 74 are attached to the transparent block portion 76g.

As illustrated in FIG. 10, the transparent block portion 76g includes printed portions 76g1 formed on side surfaces of the transparent block portion 76g, printed portions 76g2 formed on inclined surfaces of the transparent block portion 76g, and printed portions 76g3 formed on the top surface of the transparent block portion 76g. The printed portions 76g1 to 76g3 do not allow light to pass therethrough and are formed on surfaces of the transparent block portion 76g.

The printed portions 76g1 and 76g2 correspond to the printed portions 76f1 of the fifth exemplary embodiment (see FIG. 9A), and the printed portions 76g3 correspond to the printed portions 76f2 of the fifth exemplary embodiment (see FIG. 9A).

Each of the printed portions 76g1 and 76g2 is another example of the light blocking member, and each of the printed portions 76g3 is another example of the edge portion.

As described above, although the transparent block portion 76g is in common with the transparent block portion 76f of the fifth exemplary embodiment in that it has a substantially rectangular cross section, the transparent block portion 76g is different from the transparent block portion 76f of the fifth exemplary embodiment in that two of the four corner portions of the transparent block portion 76g are chamfered so as to form the inclined surfaces, whereas the transparent block portion 76f is not chamfered.

The top surface on which the printed portions 76g3 are formed is adjacent to the inclined surfaces on which the printed portions 76g2 are formed.

In addition, the angle formed by the top surface and each of the inclined surfaces is 90 degrees or larger and is an obtuse angle. Accordingly, the inclined surfaces block light, and thus, light blocking is performed with higher certainty compared with the case where corner portions block light.

Note that the integral block portion 76e according to the above-described fourth exemplary embodiment may be chamfered like the transparent block portion 76g of the sixth exemplary embodiment.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An optical device comprising:

a light guiding unit that emits light to be guided to a predetermined position from a light emitting aperture;

a detection unit that receives light reflected at the predetermined position; and

a light blocking unit that includes a light blocking member located closer than an imaginary line to the detection unit in a cross section including the predetermined position and the light guiding unit, the imaginary line connecting the predetermined position and an end of the light emitting aperture that is far from the predetermined position in an optical axis direction.

(((2)))

The optical device according to (((1))),

wherein the light blocking unit includes an edge portion that allows light reflected at the predetermined position and travelling toward the detection unit to pass through the edge portion and that does not allow light reflected at another position different from the predetermined position and travelling toward the detection unit to enter the edge portion.

(((3)))

The optical device according to (((2))),

wherein the edge portion is formed integrally with the light blocking member.

(((4)))

The optical device according to (((3))),

wherein a lens on which light reflected at the predetermined position is incident is mounted on a member including the edge portion and the light blocking member integrally formed with each other.

(((5)))

The optical device according to (((3))),

wherein a member including the edge portion and the light blocking member integrally formed with each other has a recess for mounting a lens on which light reflected at the predetermined position is incident onto the member.

(((6)))

The optical device according to (((3))),

wherein the edge portion and the light blocking member are formed on a surface of a transparent member.

(((7)))

The optical device according to (((2))),

wherein the edge portion has an inner surface facing toward the detection unit.

(((8)))

The optical device according to (((1))),

wherein the light blocking member is formed on two adjacent surfaces of a transparent member.

(((9)))

The optical device according to (((8))),

wherein the two adjacent surfaces form an obtuse angle.

(((10)))

An image reading device comprising:

a light guiding unit that emits light to be guided to an image reading position from a light emitting aperture;

a detection unit that receives light reflected at the image reading position; and

a light blocking unit that includes a light blocking member located closer than an imaginary line to the detection unit in a cross section including the image reading position and the light guiding unit, the imaginary line connecting the image reading position and an end of the light emitting aperture that is far from the image reading position in an optical axis direction.

What is claimed is:

1. An optical device comprising:
a light guiding unit that emits light to be guided to a predetermined position from a light emitting aperture;
a detection unit that receives light reflected at the predetermined position; and
a light blocking unit that includes a light blocking member located closer than an imaginary line to the detection unit in a cross section including the predetermined position and the light guiding unit, the imaginary line connecting the predetermined position and an end of the light emitting aperture that is far from the predetermined position in an optical axis direction.

2. The optical device according to claim 1,
wherein the light blocking unit includes an edge portion that allows light reflected at the predetermined position and travelling toward the detection unit to pass through the edge portion and that does not allow light reflected at another position different from the predetermined position and travelling toward the detection unit to enter the edge portion.

3. The optical device according to claim 2,
wherein the edge portion is formed integrally with the light blocking member.

4. The optical device according to claim 3,
wherein a lens on which light reflected at the predetermined position is incident is mounted on a member including the edge portion and the light blocking member integrally formed with each other.

5. The optical device according to claim 3,
wherein a member including the edge portion and the light blocking member integrally formed with each other has a recess for mounting a lens on which light reflected at the predetermined position is incident onto the member.

6. The optical device according to claim 3,
wherein the edge portion and the light blocking member are formed on a surface of a transparent member.

7. The optical device according to claim 2,
wherein the edge portion has an inner surface facing toward the detection unit.

8. The optical device according to claim 1,
wherein the light blocking member is formed on two adjacent surfaces of a transparent member.

9. The optical device according to claim 8,
wherein the two adjacent surfaces form an obtuse angle.

10. An image reading device comprising:
a light guiding unit that emits light to be guided to an image reading position from a light emitting aperture;
a detection unit that receives light reflected at the image reading position; and
a light blocking unit that includes a light blocking member located closer than an imaginary line to the detection unit in a cross section including the image reading position and the light guiding unit, the imaginary line connecting the image reading position and an end of the light emitting aperture that is far from the image reading position in an optical axis direction.

11. An optical device comprising:
a light guiding means for emitting light to be guided to a predetermined position from a light emitting aperture;
a detection means for receiving light reflected at the predetermined position; and
a light blocking unit including a light blocking member located closer than an imaginary line to the detection unit in a cross section including the predetermined position and the light guiding unit, the imaginary line connecting the predetermined position and an end of the light emitting aperture that is far from the predetermined position in an optical axis direction.
